(19) United States
(12) Patent Application Publication
(10) Pub. No.: US 2020/0356927 A1
(43) Pub. Date: Nov. 12, 2020

(54) BALANCING ACQUISITION AND ENGAGEMENT FOR TRANSPORTATION PROVIDERS AND TRANSPORTATION REQUESTERS OVER MULTIPLE TIME HORIZONS

(71) Applicant: Lyft, Inc., San Francisco, CA (US)

(72) Inventors: Jose Alberto Abelenda, El Cerrito, CA (US); Alkan William Borges, Palo Alto, CA (US); Anna Grace Campanelli, Oakland, CA (US); Carolyn Jones Conway, Redwood City, CA (US); Ismail Can Coskuner, Lafayette, CA (US); Jared Matthew Gabor, San Francisco, CA (US); Alok Gupta, San Francisco, CA (US); Langfei He, Bellevue, WA (US); Robert Bryant Kaspar, San Francisco, CA (US); Ivan Kirigin, Redwood City, CA (US); Patrick Michael McGrath, San Francisco, CA (US); Quang Huy Nguyen, San Francisco, CA (US); Ajay Pankaj Sampat, San Francisco, CA (US); Karthik Subramaniam, Oakland, CA (US); Muhammad Usman, Sunnyvale, CA (US); Su Wang, Burlingame, CA (US)

(21) Appl. No.: 16/404,422

(22) Filed: May 6, 2019

(51) Int. Cl. G06Q 10/06

(52) U.S. Cl. CPC G06Q 10/06311; G06Q 10/067

(57) ABSTRACT

This disclosure describes a transportation matching system that utilizes one or more balancer models to generate an electronic communication distribution strategy based on relative impacts of provider-specific and requester-specific levers over a target time horizon. The disclosed systems utilize the balancer models to generate predictive functions for providers and requesters to determine lever content to distribute (e.g., within electronic communications) to providers and/or requesters to efficiently and/or effectively produce acquisition and/or engagement for a target time horizon. Based on the predictive functions, the disclosed systems generate an electronic communication distribution strategy to provide (or cause to be provided) electronic communications to providers and requesters to efficiently and effectively increase or decrease acquisition and/or engagement.

### BACKGROUND

In recent years, both popularity and usage of on-demand transportation matching systems have increased. Indeed, the proliferation of web and mobile applications enable requesting individuals to request transportation from one geographic location to another. For instance, an on-demand transportation matching system can receive transportation requests and pair the requests with providers that can transport requesting individuals to destination locations.

Despite the advances of these systems, conventional on-demand transportation matching systems continue to suffer from a number of disadvantages. For example, conventional on-demand transportation matchings systems are inefficient and ineffective when it comes to managing the acquisition and engagement of both transportation providers and transportation requesters across various geographic regions and periods of time.

These along with additional problems and issues exist with conventional on-demand transportation matching systems.

### SUMMARY

This disclosure describes one or more embodiments of methods, non-transitory computer-readable media, and systems that solve the foregoing problems in addition to providing other benefits. While this summary refers to systems for simplicity, the summary also applies to certain disclosed methods and non-transitory computer-readable media. To solve the foregoing and other problems, the disclosed systems can determine an electronic communication distribution strategy based on balancing acquisition and engagement for providers and requesters across multiple time horizons. Based on the electronic communication distribution strategy, the disclosed systems can precisely distribute electronic communications to individual transportation providers and/or requesters to effectively produce acquisition and/or engagement. To elaborate, the disclosed systems can utilize multiple acquisition-engagement balancer models, each corresponding to a respective time horizon, to generate balanced acquisition-engagement functions that represent balances between predicted acquisition and predicted engagement for providers and requesters based on particular acquisition levers and engagement levers. Because of the differences in acquisition levers, engagement levers, and time horizons, the acquisition-engagement balancer models can arrive at different solutions of how to distribute electronic messages. Thus, the disclosed systems can further generate an overall electronic communication distribution strategy for more efficient resource distribution throughout one or more geographical regions based on a weighted combination of the various balanced acquisition-engagement functions associated with the acquisition-engagement balancer models.

The following description sets forth additional features and advantages of one or more embodiments of the disclosed methods, non-transitory computer-readable media, and systems. In some cases, such features and advantages are evident to a skilled artisan from the description or learned by the practice of the disclosed embodiments.

### BRIEF DESCRIPTION OF THE DRAWINGS

The detailed description refers to the drawings briefly described below.

FIG. 1 illustrates a block diagram of an environment for implementing a dynamic transportation matching system in accordance with one or more embodiments.

FIG. 2 illustrates an example flow of generating a balanced acquisition-engagement function in accordance with one or more embodiments.

FIG. 3 illustrates example components for generating a predicted provider function in accordance with one or more embodiments.

FIG. 4 illustrates example components for generating a predicted requester function in accordance with one or more embodiments.

FIG. 5 illustrates an example flow for generating a balanced acquisition-engagement function in accordance with one or more embodiments.

FIG. 6 illustrates example weighting of balancer models based on a target time horizon in accordance with one or more embodiments.

FIG. 7 illustrates an alternative embodiment for utilizing one or more balancer models in accordance with one or more embodiments.

FIG. 8 illustrates an example process for training a balancer model in accordance with one or more embodiments.

FIG. 9 illustrates a block diagram of an example computing device including various components of a transportation matching system in accordance with one or more embodiments.

FIG. 10 illustrates an example flow of acts for generating an electronic communication distribution strategy in accordance with one or more embodiments.

FIG. 11 illustrates a block diagram of a computing device for implementing one or more embodiments of the present disclosure.

FIG. 12 illustrates an example environment for a dynamic transportation matching system in accordance with one or more embodiments.

### DETAILED DESCRIPTION

This disclosure describes a dynamic transportation matching system that utilizes one or more acquisition-engagement balancer models to determine an electronic communication distribution strategy for providing electronic communications to transportation providers and/or transportation requesters. In some embodiments, the transportation matching system can determine an electronic communication distribution strategy based on balancing several factors such as acquiring new providers, acquiring new requesters, engaging existing provider, and engaging existing requesters. In addition, the transportation matching system can determine the electronic communication distribution strategy based on a balance over multiple time horizons. By determining the electronic communication distribution strategy in this way, the transportation matching system intelligently determines how and when to effectively distribute electronic communications to both providers and requesters, including indications of what types of electronic communications to provide to whom at what distribution times.

To determine an electronic communication distribution strategy, the transportation matching system can generate predictions for transportation providers and transportation requesters. Particularly, the transportation matching system can generate predicted acquisition and engagement for both providers and requesters with respect to a particular time horizon (e.g., 1 week or 6 months) and for one or more geographic regions. In some embodiments, the transportation matching system receives input from an administrator device associated with a system administrator to set a target time horizon and/or a geographic region. For instance, the transportation matching system can receive an indication to set the target time horizon at a particular duration (e.g., 1 week, 2 weeks, 2 months, etc.) over which the transportation matching system generates an electronic communication distribution strategy based on predictions of acquisition and engagement for providers and requesters.

Based on the target time horizon, the transportation matching system can weight acquisition-engagement functions that are generated over a plurality of different time horizons to generate an overall prediction of a balance between acquisition and engagement for both providers and requesters over various time horizons. In particular, the transportation matching system can utilize acquisition-engagement balancer models to generate balanced acquisition-engagement functions, each corresponding to a respective time horizon. Additionally, the transportation matching system can weight the balanced acquisition-engagement functions associated with the acquisition-engagement balancer models in accordance with the target time horizon to ultimately generate, based on a weighted combination of the different time-horizon-specific acquisition-engagement functions, an electronic communication distribution strategy for the target time horizon.

To generate the predictions of acquisition and engagement to use as a basis for an electronic communication distribution strategy, the transportation matching system can utilize one or more acquisition-engagement balancer models to generate provider-based and requester-based acquisition-engagement functions. To elaborate, the transportation matching system can generate, for one or more providers, a predicted provider function that represents a balance between how a particular acquisition lever will affect acquisition with respect to the provider(s) and how a particular engagement lever will affect engagement with respect to the provider(s). In a similar fashion, for a given requester, the transportation matching system can generate, for one or more requesters, a predicted requester function that represents a balance between how a particular acquisition lever will affect acquisition with respect to the requester(s) and how a particular engagement lever will affect engagement with respect to the requester(s).

As mentioned, the predicted provider function and the predicted requester function are specific to a particular time horizon. Indeed, in some embodiments, the transportation matching system generates the predicted provider function and the predicted requester function for a particular time horizon to represent a prediction of how the different levers will affect acquisition and engagement over the time horizon for providers and requesters, respectively. Based on the predicted provider function and the predicted requester function, the transportation matching system can further generate a balanced acquisition-engagement function that represents a balance of total spend between providers and requesters to maximize (or improve) a total transportation value (which can be determined through simulations of how marginal supply and demand are distributed spatially) at various possible spend points—e.g., a balance of the predicted provider function and the predicted requester function over a particular time horizon.

Indeed, not only can the transportation matching system balance acquisition-specific and engagement-specific predictions for providers and requesters, but the transportation matching system can further balance provider-specific predictions and requester-specific predictions. To elaborate, the transportation matching system can generate balanced acquisition-engagement functions that represent a balance (non-linear) between provider resource spend and requester resource spend to maximize a transportation value at various possible spend points. For instance, the acquisition-engagements functions represent a balance between predicted provider functions and predicted requester functions, which are in turn respectively based on provider-specific and requester-specific acquisition and engagement relative to particular levers over particular time horizons, as mentioned above. In some embodiments, the transportation matching system can utilize a plurality of acquisition-engagement balancer models to generate a plurality of balanced acquisition-engagement functions, each corresponding to a different time horizon.

As mentioned, the transportation matching system can weight the balanced acquisition-engagement functions corresponding to the different acquisition-engagement balancer models in accordance with a target time horizon. Indeed, to generate an electronic communication distribution strategy for how to distribute electronic communications to individual providers and requesters over the target time horizon, the transportation matching system can apply different weights to the different time-horizon-specific balanced acquisition-engagement functions, weighting some more than others to generate an accurate representation of acquisition and engagement for providers and requesters over the target time horizon.

Further, to determine which electronic communications to provide to which providers and requesters, the transportation matching system can repeat the process described above for the target time horizon to generate multiple weighted combinations of balanced acquisition-engagement functions, each corresponding to different combinations of acquisition levers and engagement levers for respective time horizons. Thus, the transportation matching system can determine which weighted combination yields the best overall result, balancing acquisition and engagement for providers and requesters over the target time horizon. Based on determining which weighted combination of balanced acquisition-engagement functions yields the best overall result, the transportation matching system can further determine the corresponding acquisition and engagement levers that led to the result and can distribute (or cause to be distributed by a third party) lever content associated with those levers within the electronic communications as part of the electronic communication distribution strategy.

To distribute electronic communications on an individualized basis, the transportation matching system can generate individual predicted provider functions and individual predicted requester functions. Indeed, as mentioned above, the transportation matching system can generate predicted provider functions and predicted requester functions that represent a balance between acquisition and engagement for providers and requesters for given levers over a given time horizon. Thus, to determine particular providers and particular requesters to whom to provide which electronic communications, the transportation matching system can generate balanced acquisition-engagement functions for various combinations of individual providers and requesters corresponding to different combinations of acquisition levers and engagement levers. Thus, based on which levers result in the best overall prediction for which providers/requesters for a target time horizon, the transportation matching system can determine which levers to include in electronic communications to distribute to which providers and requesters.

As outlined above, the transportation matching system provides several advantages and benefits over conventional on-demand transportation matching systems. For instance, the transportation matching system improves accuracy over conventional systems by utilizing more specific, granular information than conventional systems. More particularly, by generating and weighting the various balanced acquisition-engagement functions over different time horizons and/or for different geographic regions, based on specific acquisition and engagement levers, and corresponding to individual providers and requesters, the transportation matching system determines which particular levers to provide to which providers and individual requesters on an individual lever and individual provider/requester level.

In addition, unlike conventional systems that rely solely on broad parameters like lifetime value, the transportation matching system can generate predictions and determine electronic communication distribution strategies for specific time horizons and/or for specific providers/requesters. For example, the transportation matching system can identify which providers or requesters are more relevant or less relevant at which particular times, and the transportation matching system can determine which electronic communications to distribute to most efficiently improve acquisition and/or engagement for total transportation value. Thus, the transportation matching system can more accurately determine which lever content to provide to which providers/requesters at what distribution times for achieving particular results in acquisition and/or engagement.

In addition, the transportation matching system improves efficiency over conventional systems. Due at least in part to the improved accuracy of the transportation matching system, the transportation matching system more efficiently utilizes computing resources such as computing time and processing power. Indeed, because the transportation matching system more accurately distributes electronic communications that more effectively yield results in producing acquisition and/or engagement in providers and requesters, the transportation matching system wastes fewer computing resources in generating and distributing electronic communications, especially when compared to conventional systems that distribute electronic communications based on a more generic, broad-spectrum analysis.

Furthermore, the transportation matching system is more flexible than conventional systems. In particular, whereas many conventional systems rigidly apply a uniform lifetime value analysis for determining distribution of electronic communications, the transportation matching system can flexibly adapt to different time horizons. Indeed, the transportation matching system can receive administrator input to adjust a target window and can modify weights associated with various acquisition-engagement balancer models to tailor an electronic communication distribution strategy to a specific target time horizon set by the administrator. Further, because the transportation matching system generates balanced acquisition-engagement functions based on individual levers and individual providers/requesters, the transportation matching system is further capable of flexibly modifying an electronic communication distribution strategy to include new (or changed) acquisition levers, engagement levers, providers, and/or requesters.

As illustrated by the foregoing discussion, the present disclosure utilizes a variety of terms to describe features and advantages of the transportation matching system. For reference, additional detail is now provided regarding the use of these terms. For example, as used herein, the term “transportation provider” (or simply “provider”) refers to a driver or other person who operates a transportation vehicle and/or who interacts with a provider device. In particular, the term provider can include a person who drives or may potentially drive a transportation vehicle along various routes to pick up and drop off requesters. In some embodiments, a provider can refer to a prospective or potential provider—e.g., someone who is not currently operating a transportation vehicle for providing transportation services but who is registered with a transportation matching system to do so in the future. In these or other embodiments, a provider can include an autonomous system, such as an autonomous vehicle. Indeed, the transportation matching system matches a provider to a received request and serves instructions to the provider regarding when and where to travel in order to fulfill the matched transportation request. In response to a provider fulfilling a request for transportation, the transportation matching system credits the provider based on, for example, the distance driven, the day and time, and any available incentives. The term provider can include both available providers (e.g., a provider with a vehicle unoccupied by any requesters) as well as providers currently transporting one or more passengers in fulfillment of a transportation request.

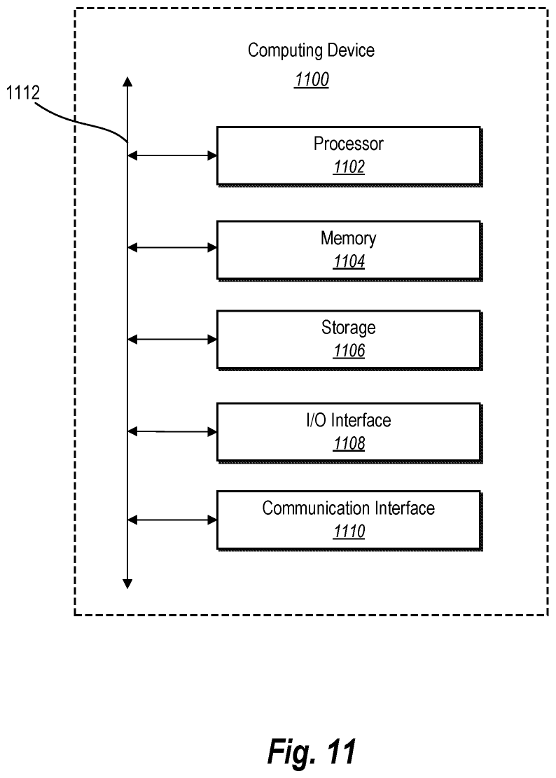

As mentioned above, providers are associated with transportation vehicles as well as provider devices. The transportation vehicle may be an airplane, automobile, bicycle, motorcycle, electric scooter, or another vehicle. As used herein, the term “provider device” refers to a computing device associated with a provider. A provider device can include a mobile device such as a laptop, smartphone, or tablet associated with the provider. However, the provider device may be any type of computing device as further explained below with reference to FIG. 11. In addition, the provider device may include provider applications that utilize web browsers, applets, or other software applications (e.g., native applications) available to the provider devices. Further, in some embodiments, a provider device is built into a transportation vehicle associated with the provider. Although this disclosure describes a provider as performing certain functions, the provider device is often performing a corresponding function. For example, when the transportation matching system sends a transportation request to a provider—or queries location information from a provider—the transportation matching system sends the transportation request or location query to the provider device associated with the provider.

As used herein, the term “transportation requester” (or simply “requester”) refers to a person (or group of people) who request pickup or other form of transportation from the transportation matching system. In particular, the term requester may include a person who requests pickup or other form of transportation but who is still waiting for pickup. A requester may also refer to a person whom a transportation vehicle (associated with a provider) has already picked up and who is currently riding within the transportation vehicle to a destination (e.g., a destination indicated by a requester). In one or more embodiments, a requester initiates a software application of the transportation matching system and whose requester device sends a query for a price estimate and/or a query for an estimated time of arrival to the transportation matching system. Accordingly, a requester enters in a pickup location and/or destination for transportation (and optionally selects a mode or transportation type) by interacting with graphical user interfaces of a requester application on their requester device.

Relatedly, the term “requester device” refers to a computing device associated with a requester. A requester device includes a mobile device such as a laptop, smartphone, or tablet associated with a requester. However, the requester device may be any type of computing device as further explained below with reference to FIG. 11. Each of the requester devices can respectively include a requester application. In some embodiments, the requester applications comprise web browsers, applets, or other software applications (e.g., native applications) available to the requester devices. Additionally, in some instances, the transportation matching system provides data packets including instructions that, when executed by the requester devices, create or otherwise integrate requester applications within an application or webpage.

As used herein, the term “time horizon” refers to a period of time having a certain duration from a start time to an end time. A time horizon can refer to a forward-looking time period from a current point in time to some future point in time. In addition, a time horizon can refer to a cohorting period (or cohorting window) such as a 1-week period, a 2-week period, a 1-month period, a 2-month period, a 6-month period, a 1-year period, or any other duration of time. In addition, a time horizon can include different time granularities that represent a resolution or increment-based division of time within a time horizon. For example, a time horizon of 1 week may include time values of days (e.g., 7 time values for the 7 days) or hours (e.g., 168 time values for the 168 hours) that make up the 1-week period. Alternatively, a time horizon of 6 months may have a coarser time granularity and may therefore include time values divided into months (e.g., 6 time values for the 6 months) or days (e.g., 180 time values for 180 days) that make up the 6-month time period. A “target time horizon” refers to a time horizon that the transportation matching system sets for generating an electronic communication distribution strategy. For example, the transportation matching system can receive input from an administrator to set a target time horizon.

As mentioned, the transportation matching system generates a predicted provider function to represent acquisition and engagement for one or more providers over a particular time horizon. As used herein, the term “predicted provider function” (or simply “provider function”) refers to a function that represents acquisition and engagement for one or more providers over a time horizon. In particular a predicted provider function can refer to a future-looking function that combines, for a time horizon, a prediction of how a particular acquisition lever will affect acquisition for one or more providers (e.g., as indicated by a provider acquisition function) with a prediction of how a particular engagement lever will affect engagement for the one or more providers (e.g., as indicated by a provider engagement function). For example, a predicted provider function can include a relationship between a resource investment such as a spend (e.g., an amount of currency allocated) and a provider-specific value (e.g., provider hours or numbers of providers).

In a similar fashion, the transportation matching system generates a predicted requester function for one or more requesters over a time horizon (e.g., the same time horizon associated with the predicted provider function). The term “predicted requester function” (or simply “requester function”) refers to a function that represents acquisition and engagement for one or more requesters over a time horizon. In particular a predicted requester function can refer to a future-looking function that combines, for a time horizon, a prediction of how a particular acquisition lever will affect acquisition for one or more requesters (e.g., as indicated by a requester acquisition function) with a prediction of how a particular engagement lever will affect engagement for the one or more requesters (e.g., as indicated by a requester engagement function). For example, a predicted requester function can include a relationship between a resource investment such as a spend (e.g., an amount of currency allocated) and a requester-specific value (e.g., requester engagement units, serviced requests, or requester sessions).

Relatedly, the term “acquisition” refers to acquiring or adding new providers and/or new requesters. For example, acquisition refers to the process of associating (e.g., registering) a new provider or a new requester with the transportation matching system who was not previously associated with the transportation matching system. Based on acquiring a new provider, the new provider can provide transportation services to requesters. Based on acquiring a new requester, the new requester can request and receive transportation from providers via the transportation matching system.

In addition, the term “engagement” refers to engaging or activating existing providers and/or requesters. For example, engagement can refer to the process of motivating an existing provider (e.g., a provider already registered with the transportation matching system) to service a transportation request. Engagement can also (or alternatively) refer to the process of motivating an existing requester (e.g., a requester already registered) to submit a transportation request.

Relatedly, the term “lever” (e.g., acquisition lever or engagement lever) refers to an action for motivating or incentivizing acquisition and/or engagement. In particular, a lever can include a distribution of digital content that is intended to produce or motivate a particular acquisition and/or engagement result. For example, a lever can refer to a purchase and/or distribution of lever content as part of an electronic communication (e.g., an email, a text message, a chat message, an audio message, a video message, or other distribution channel) including digital text, digital images, digital audio, or digital video to promote or incentivize a product or service.

Relatedly, the term “lever content” refers to targeted digital content associated with a lever. For example, lever content can include an electronic communication that includes an offer or incentive to motivate acquisition and/or engagement on the part of a provider and/or requester. The transportation matching system can provide lever content in accordance with an acquisition lever and/or an engagement lever (e.g., within an electronic communication as part of an electronic communication distribution strategy). Indeed, the transportation matching system can utilize provider acquisition levers (e.g., advertisements to attract new providers), provider engagement levers (e.g., incentives such as personalized power zones where provider payment for transportation services within the geographic area of the power zone is increased), requester acquisition levers (e.g., advertisements to attract new requesters), and/or requester engagement levers (e.g., incentives such as ride streak offers or discounts for, or credit toward, particular transportation requests).

As used herein, the term “electronic communication distribution strategy” refers to a plan, strategy, or campaign for distributing electronic communications or causing electronic communications to be distributed (e.g., by causing a third party to distribute electronic communications). Particularly, an electronic communication distribution strategy indicates when and how and what types of electronic communications to provide to whom. For instance, an electronic communication distribution strategy can indicate the method for distributing electronic communications based on a plurality of combinations of levers, time values (or time horizons), providers, and/or requesters. As an example, based on a particular combination of a particular lever (e.g., a provider acquisition lever) corresponding to a particular time value within a particular time horizon, and further corresponding to a particular provider identification, the transportation matching system can distribute lever content (e.g., a provider incentive) at the particular time and to the particular provider.

As mentioned, the transportation matching system can generate a balanced acquisition-engagement function based on a predicted provider function and a predicted requester function. As used herein, the term “balanced acquisition-engagement function” (or simply “acquisition-engagement function”) refers to a function that represents, for a given time horizon, a balance of spend for of provider acquisition, provider engagement, requester acquisition, and requester engagement to maximize or otherwise improve total transportation value at various spend points over a time horizon. Indeed, the transportation matching system can generate a balanced acquisition-engagement function by weighting a predicted provider function and a predicted requester function.

To generate a balanced acquisition-engagement function, the transportation matching system can utilize an acquisition-engagement balancer model. As used herein, the term “acquisition-engagement balancer model” (or simply “balancer model”) refers to a model or algorithm that analyzes various parameters and/or functions such as provider acquisition functions, provider engagement functions, requester acquisition functions, and/or requester engagement functions to generate balanced acquisition-engagement functions. In some embodiments, an acquisition-engagement balancer model includes a machine learning model such as a neural network or a reinforcement learning model that is trainable based on training data to learn weights to apply to various parameters and/or functions to improve its prediction accuracy.

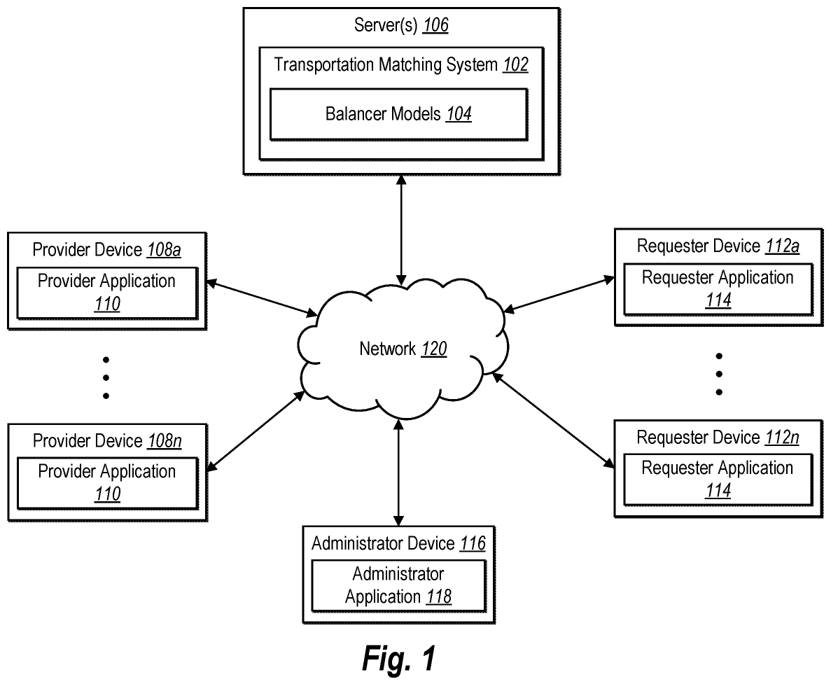

Additional detail will now be provided with reference to the figures. The description with respect to FIG. 1 provides an overview of the transportation matching system. Much of the disclosure thereafter describes components and processes of the transportation matching system in further detail with reference to subsequent figures.

To illustrate, FIG. 1 includes a block diagram of an environment for implementing a transportation matching system 102 in accordance with one or more embodiments. As shown in FIG. 1, the environment includes the transportation matching system 102 on the server(s) 106, provider devices 108a-108n, requester devices 112a-112n, and administrator device 116, and a network 120. The server(s) 106 can include one or more computing devices to implement the transportation matching system 102. Additional description regarding the illustrated devices (106, 108a-108n, 112a-112n, and 116) is provided with respect to FIG. 11 below.

As shown, the transportation matching system 102 utilizes the network 120 to communicate with the provider devices 108a-108n, the requester devices 112a-112n, and the administrator device 116. For example, the transportation matching system 102 communicates with the provider devices 108a-108n and the requester devices 112a-112n via the network 120 to determine locations of the provider devices 108a-108n and the requester devices 112a-112n, respectively. In some embodiments, per device settings, the transportation matching system 102 may receive location coordinates from the provider devices 108a-108n and/or the requester devices 112a-112n to indicate a geocoded area (e.g., a geohash) where the provider devices 108a-108n and/or the requester devices 112a-112n are located. In addition, the transportation matching system 102 may receive transportation requests from requester devices 112a-112n that indicate transportation request information such as an origin, a destination, and a time.

To facilitate connecting requests with transportation provider vehicles, the transportation matching system 102 further communicates with the provider devices 108a-108n (e.g., through a provider application 110) and with the requester devices 112a-112n (e.g., through a requester application 114). Indeed, as shown in FIG. 1, each of the provider devices 108a-108n include a provider application 110. In many embodiments, the transportation matching system 102 communicates with the provider devices 108a-108n through the provider application 110 to, for example, receive and provide information including request information, provider information (e.g., provider identification, provider acquisition information, and provider engagement information), and/or electronic communications including lever content associated with one or more levers. Additionally, the provider application 110 optionally includes computer-executable instructions that, when executed by the provider devices 108a-108n, cause the provider devices 108a-108n to perform certain functions. For instance, the provider application 110 can cause the provider devices 108a-108n to communicate with the transportation matching system 102 to navigate to various places such as a target area, a requester's pickup location, a requester's destination location, as well as collect fares and bonuses for completed transportation requests. In addition, the provider application

Relatedly, as mentioned above, each of the requester devices 112a-112n includes a requester application 114. In many embodiments, the transportation matching system 102 communicates with the requester devices 112a-112n through the requester application 114 to, for example, receive and provide information including request information, requester information (e.g., requester identification, requester acquisition information, and requester engagement information), and/or electronic communications including lever content associated with one or more levers. A requester may use a requester application 114 to, via a requester interface, request transportation services, receive a price estimate for the transportation service, and access other transportation-related services. For example, a requester may interact with the requester device 112a through graphical user interfaces of the requester application 114 to enter a pickup location and a destination for transportation. The transportation matching system 102 can, in turn, provide to the requester device 112a, an estimated time of arrival of a provider (or transportation vehicle), or access to other transportation-related services through the requester application 114.

As illustrated, the environment also includes an administrator device 116. The transportation matching system 102 can communicate with the administrator device 116 (e.g., via the administrator application 118) to receive and provide information such as an indication of a target time horizon, a selection to start an electronic communication distribution strategy, and indications of one or more acquisition levers and engagement levers. For example, the administrator application 118 can include one or more administrator interface elements for arranging an electronic communication distribution strategy, including setting a target time horizon and selecting various levers (e.g., ad purchases) to utilize for providing lever content (e.g., within electronic communications for distribution).

As further illustrated in FIG. 1, the transportation matching system 102 includes one or more acquisition-engagement balancer models 104. To elaborate, the transportation matching system 102 utilizes the balancer models 104 to analyze acquisition functions and engagement functions for both providers and requesters to generate predictions of function acquisition and engagement for the providers and requesters, respectively. In addition, the transportation matching system 102 utilizes the balancer models 104 to generate balanced combinations of the predictions (e.g., as represented by predicted provider functions and predicted requesters functions) to generate balanced acquisition-engagement functions over different time horizons. Further the transportation matching system 102 weights the different balanced acquisition-engagement functions to generate an overall result indicating a balance between the acquisition-engagement functions over the various time horizons based on receiving or detecting an indication of a target time horizon from the administrator device 116.

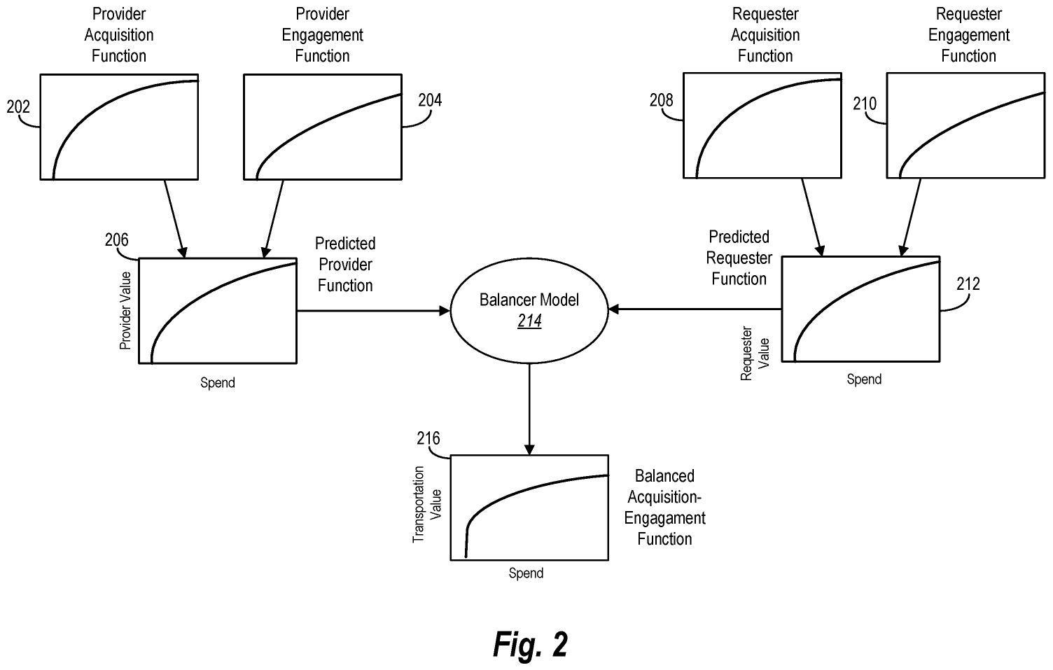

As mentioned, the transportation matching system 102 utilizes balancer models (e.g., the balancer models 104) to generate balanced acquisition-engagement functions based on provider acquisition information, provider engagement information, requester acquisition information, and requester engagement information. Indeed, FIG. 2 illustrates an example flow of generating a balanced acquisition-engagement function 216. The description of FIG. 2 provides a general overview of utilizing a balancer model 214 (from among the balancer models 104) to generate the balanced acquisition-engagement function 216. Thereafter, the description of the subsequent figures provides additional detail regarding the various methods and processes involved.

As shown in FIG. 2, the transportation matching system 102 generates a predicted provider function 206 based on a provider acquisition function 202 and a provider engagement function 204. To elaborate, the transportation matching system 102 generates a predicted provider function 206 that represents a prediction of how different spend amounts affect a given provider value. To generate the prediction, the transportation matching system 102 analyzes acquisition information and engagement information for one or more providers, as represented by the provider acquisition function 202 and the provider engagement function 204, respectively. Indeed, to generate the provider acquisition function 202, the transportation matching system 102 analyzes past information regarding acquisition of various providers with respect to particular provider acquisition levers. Likewise, to generate the provider engagement function 204, the transportation matching system 102 analyzes information regarding engagement of providers with respect to particular provider engagement levers.

In some embodiments, the provider acquisition function 202 and the provider engagement function 204 on which the transportation matching system 102 bases the prediction (e.g., the predicted provider function 206) are specific to a particular provider (or a particular group of providers that share common attributes such as geographic location and/or active hours) as indicated by a provider identification (e.g., a provider phone number, a provider system identification number, or a provider username). Thus, the provider acquisition function 202 is a visual representation of how a provider value (e.g., a number of providers or a number of provider hours) of the particular provider(s) changes with respect to increases and decreases in acquisition spend. Similarly, the provider engagement function 204 is a visual representation of how a provider value changes with respect to increases and decreases in engagement spend.

In the same or other embodiments, the provider acquisition function 202 and the provider engagement function 204 are specific to a particular provider acquisition lever (or a set of acquisition levers) and a particular provider engagement lever (or a set of engagement levers), respectively. Thus, the provider acquisition function 202 represents how a provider value is affected by increases and decreases in spend with respect to a given acquisition lever—e.g., to increase distribution of lever content associated with the acquisition lever or decrease distribution of lever content associated with the acquisition lever (e.g., by providing the lever content to a greater number of potential providers and/or by providing the lever content in greater volume/frequency). Likewise, the provider engagement function 204 represents how a provider value of the provider(s) is affected by increases and decreases in spend with respect to a given engagement lever—e.g., to increase or decrease distribution of the engagement lever content (e.g., by providing the lever content to a greater number of providers and/or by providing the lever content in greater volume/frequency to the providers).

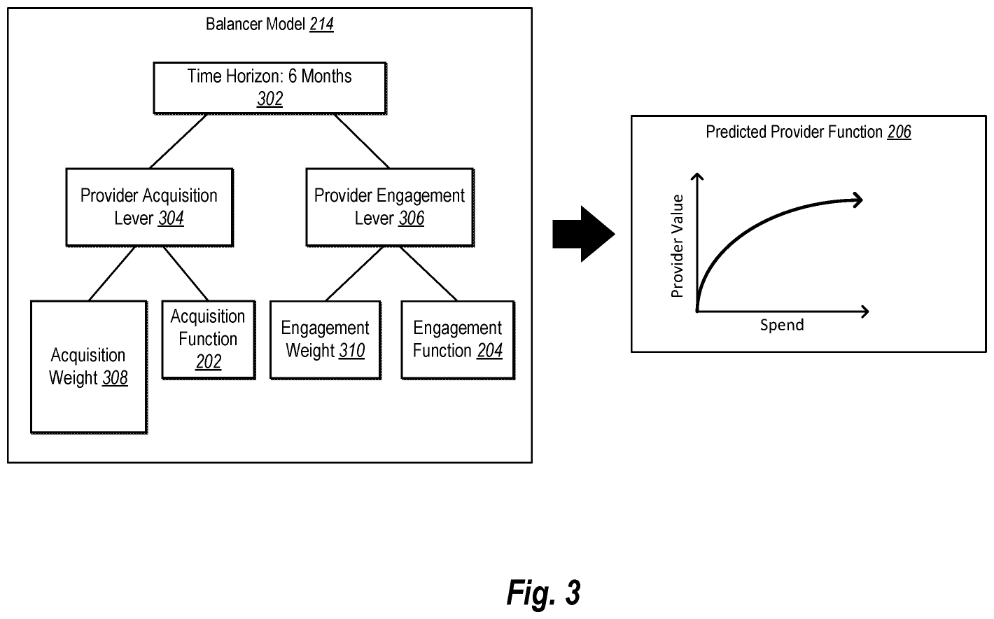

Based on the provider acquisition function 202 and the provider engagement function 204, the transportation matching system 102 generates the predicted provider function 206. Indeed, the predicted provider function 206 is a visual representation of a balance or weighted combination between provider acquisition and provider engagement with respect to particular provider(s) and particular levers. To generate the predicted provider function 206, the transportation matching system 102 weights the provider acquisition function 202 and the provider engagement function 204. In some embodiments, the transportation matching system 102 weights the provider acquisition function 202 and the provider engagement function 204 equally. In other embodiments, the transportation matching system 102 applies a provider acquisition weight that is greater or less than the provider engagement weight, depending on any indications from an administrator (e.g., via the administrator device 116) to target provider acquisition or provider engagement by utilizing levers to distribute lever content via an electronic communication distribution strategy. Additional detail regarding generating the predicted provider function 206 is provided below with reference to FIG. 3.

As further illustrated, the transportation matching system 102 generates a predicted requester function 212 based on a requester acquisition function 208 and a requester engagement function 210. To elaborate, the transportation matching system 102 the transportation matching system 102 generates a predicted requester function 212 that represents a prediction of how different spend amounts affect a given requester value. To generate the prediction, the transportation matching system 102 analyzes acquisition information and engagement information for one or more requesters, as represented by the requester acquisition function 208 and the requester engagement function 210, respectively. Indeed, to generate the requester acquisition function 208, the transportation matching system 102 analyzes past information regarding acquisition of various requesters with respect to particular requester acquisition levers. Likewise, to generate the requester engagement function 210, the transportation matching system 102 analyzes information regarding engagement of requesters with respect to particular requester engagement levers.

In some embodiments, the requester acquisition function 208 and the requester engagement function 210 on which the transportation matching system 102 bases the prediction (e.g., the predicted requester function 212) are specific to a particular requester (or a particular group of requesters that share common attributes such as geographic location and/or requesting times) as indicated by a requester identification (e.g., a requester phone number or a requester username). Thus, the requester acquisition function 208 is a visual representation of how a requester value (e.g., a number of requesters, a number of received requests, a number of matched requests, or a number of requester application sessions) of the particular requester(s) changes with respect to increases and decreases in acquisition spend. Similarly, the requester engagement function 204 is a visual representation of how a requester value changes with respect to increases and decreases in engagement spend.

In the same or other embodiments, the requester acquisition function 208 and the requester engagement function 210 are specific to a particular requester acquisition lever (or a set of acquisition levers) and a particular requester engagement lever (or a set of engagement levers), respectively. Thus, the requester acquisition function 208 represents how a requester value is affected by increases and decreases in spend with respect to a given acquisition lever—e.g., to increase distribution of lever content associated with the acquisition lever or decrease distribution of lever content associated with the acquisition lever (e.g., by providing the lever content to a greater number of potential requesters and/or by providing the lever content in greater volume/frequency). Likewise, the requester engagement function 210 represents how a requester value of the requester(s) is affected by increases and decreases in spend with respect to a given engagement lever—e.g., to increase or decrease distribution of lever content associated with the engagement lever (e.g., by providing the lever content to a greater number of requesters and/or by providing the lever content in greater volume/frequency to the requesters).

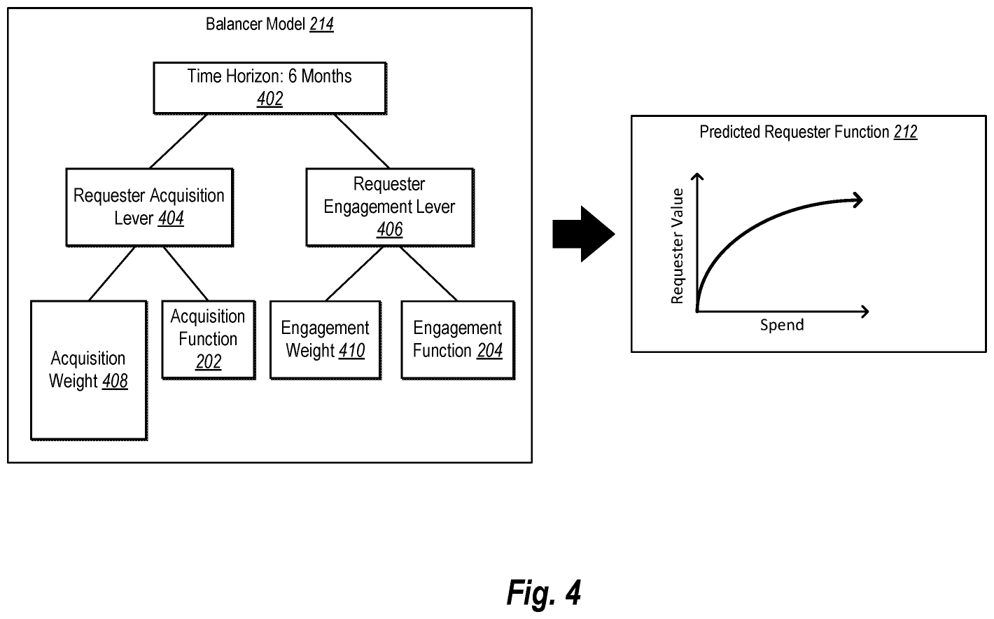

Based on the requester acquisition function 208 and the requester engagement function 210, the transportation matching system 102 generates the predicted requester function 212. Indeed, the predicted requester function 212 is a visual representation of a balance or weighted combination between requester acquisition and requester engagement with respect to particular requester(s) and particular levers. To generate the predicted requester function 212, the transportation matching system 102 weights the requester acquisition function 208 and the requester engagement function 210. In some embodiments, the transportation matching system 102 weights the requester acquisition function 208 and the requester engagement function 210 equally. In other embodiments, the transportation matching system 102 applies a requester acquisition weight that is greater or less than the requester engagement weight, depending on any indications from an administrator (e.g., via the administrator device 116) to target requester acquisition or requester engagement by distributing lever content associated with levers via an electronic communication distribution strategy. Additional detail regarding generating the predicted requester function 212 is provided below with reference to FIG. 4.

As further illustrated in FIG. 2, the transportation matching system 102 utilizes the balancer model 214 to generate the balanced acquisition-engagement function 216. To illustrate, the transportation matching system 102 applies the balancer model 214 to generate the balanced acquisition-engagement function 216 as a balanced combination of constituent functions to provide an overall representation provider acquisition, provider engagement, requester acquisition, and requester engagement. The transportation matching system 102 generates the balanced acquisition-engagement function 216 to maximize or otherwise improve total transportation value for spend points over a time horizon. For example, the transportation matching system 102 balances the predicted provider function 206 with the predicted requester function 212.

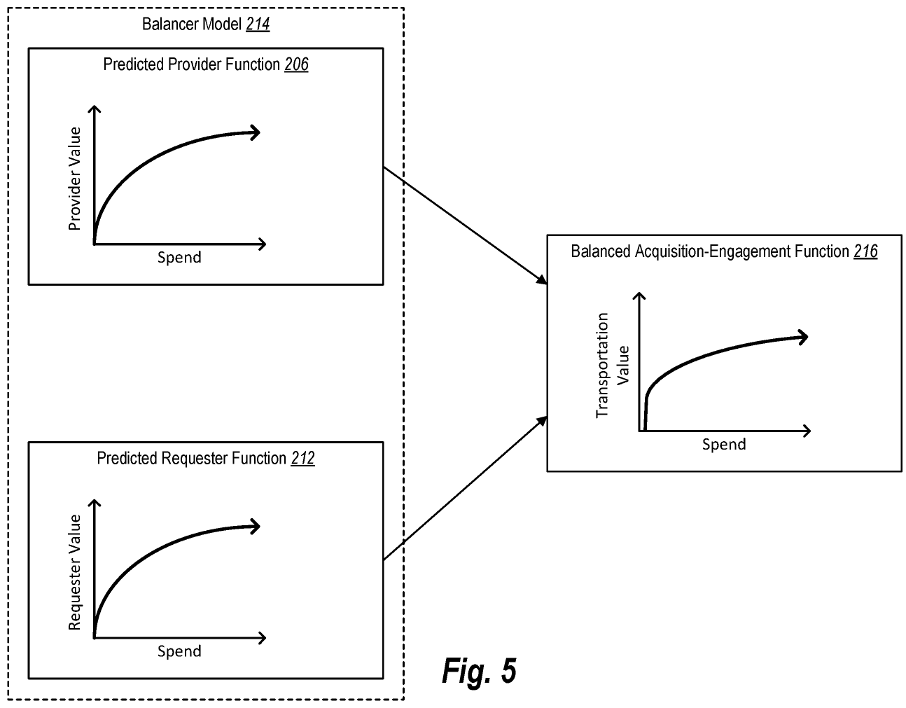

In some embodiments, the transportation matching system 102 applies a provider function weight to the predicted provider function 206 and applies a requester function weight to the predicted requester function 212. Depending on input from an administrator (e.g., via the administrator device 116) to set parameters for an electronic communication distribution strategy, the transportation matching system 102 applies provider function weights and requester function weights that are equal to, or different from (e.g., less than or greater than), each other. For instance, the transportation matching system 102 can receive administrator input to target providers or requesters, whereupon the transportation matching system 102 can, respectively, weight the predicted provider function 206 or the predicted requester function 212 more heavily. Additional detail regarding generating the balanced acquisition-engagement function 216 is provided below with reference to FIG. 5.

As mentioned, the transportation matching system 102 generates a predicted provider function based on provider-specific acquisition information and provider-specific engagement information. Indeed, FIG. 3 illustrates example components that the transportation matching system 102 utilizes to generate the predicted provider function 206. As illustrated, the transportation matching system 102 utilizes the balancer model 214 to generate the predicted provider function 206 based on a weighted combination of the provider acquisition function 202 and the provider engagement function 204.

Particularly, the transportation matching system 102 generates the provider acquisition function 202 based on provider-specific acquisition information with respect to a particular provider acquisition lever 304. For instance, the transportation matching system 102 determines a historical increase or decrease in a provider value (e.g., a number of provider hours) based on exposure to lever content associated with the provider acquisition lever 304. Indeed, based on previous distributions using the provider acquisition lever 304 to one or more providers, the transportation matching system 102 determines how the provider acquisition lever 304 affects acquisition of new providers and can therefore generate the provider acquisition function 202 to represent the relationship between different amounts of spend to distribute lever content in accordance with the provider acquisition lever 304 and the corresponding changes in provider value.

In a similar fashion, the transportation matching system 102 generates the provider engagement function 204 based on historical information regarding distribution of lever content associated with the provider engagement lever 306. Particularly, the transportation matching system 102 determines an increase or decrease in a provider value based on distributing electronic communications containing lever content corresponding to the provider engagement lever 306 to existing providers. Thus, the transportation matching system 102 generates the provider engagement function 204 to represent the relationship between different amounts of spend for the provider engagement lever 306 and the corresponding changes in provider value.

Based on generating the provider acquisition function 202 and the provider engagement function 204 with respect to historical performance of the provider acquisition lever 304 and the provider engagement lever 306, the transportation matching system 102 generates a projection or prediction of provider acquisition and engagement for a particular time horizon 302. For instance, the transportation matching system 102 receives and records responses to the provider acquisition lever 304 and the provider engagement lever 306, and the transportation matching system 102 timestamps the responses to determine times when particular levers elicit such responses. As illustrated in FIG. 3, the transportation matching system 102 generates the predicted provider function 206 for a time horizon 302 of 6 months. Indeed, the transportation matching system 102 generates the predicted provider function 206 to represent how different amounts of spend correspond to different levels of provider value, balanced between acquisition and engagement. Although FIG. 3 illustrate a particular time horizon 302, in some embodiments, the transportation matching system 102 generates many predicted provider functions over a variety of time horizons, longer and/or short than 6 months.

Based on the time horizon 302, the transportation matching system 102 determines a provider acquisition weight 308 associated with the provider acquisition lever 304 and a provider engagement weight 310 associated with the provider engagement lever 306. For example, depending on the duration of the time horizon 302, the transportation matching system 102 determines larger or smaller values for the provider acquisition weight 308 and the provider engagement weight 310. Indeed, for the 6-month time horizon 302 shown in FIG. 3, the transportation matching system 102 determines a provider acquisition weight 308 larger than the provider engagement weight 310 (as shown by the larger box) because, in many circumstances, larger investments in acquisition are more beneficial to increasing overall provider value over longer time horizons. Thus, the transportation matching system 102 generates the predicted provider function 206 to represent a weighted combination of how, for the time horizon 302, spend corresponds to provider value from a combined acquisition-engagement perspective.

As mentioned, the transportation matching system 102 further generates a predicted requester function 212. Indeed, FIG. 4 illustrates example components that the transportation matching system 102 utilizes to generate the predicted requester function 212. As shown, the transportation matching system 102 utilizes the balancer model 214 to generate the predicted requester function 212 based on a weighted combination of the requester acquisition function 208 and the requester engagement function 210.

Particularly, the transportation matching system 102 utilizes historical information regarding acquisition of requesters based on exposure to a particular requester acquisition lever 404 and further regarding engagement of requesters based on exposure to a particular requester engagement lever 406. For example, the transportation matching system 102 determines how (and at what particular time values) distribution of lever content associated with the requester acquisition lever 404 correlates to acquisition of new requesters to then generate the requester acquisition function 208 to represent this relationship. In addition, the transportation matching system 102 determines how (and at what time values) distribution of lever content associated with the requester engagement lever 406 correlates to engagement of existing requesters to then generate the requester engagement function 210. The requester acquisition function 208 and the requester engagement function 210 each represent a relationship between amounts of spend for respective levers and resulting requester values.

Similar to the above discussion regarding the predicted provider function 206, the transportation matching system 102 utilizes the balancer model 214 to generate the predicted requester function 212 for a particular time horizon 302. Indeed, based on historical acquisition and engagement information, the transportation matching system 102 generates a prediction of how spend will correspond to requester value for a particular forward-looking time period.

Based on the time horizon 302, the transportation matching system 102 determines and applies a requester acquisition weight 408 associated with the requester acquisition lever 404 and a requester engagement weight 410 associated with the requester engagement lever 406 to reflect, respectively, a predicted impact of each lever over the time horizon 302. In some embodiments, the transportation matching system 102 applies a requester acquisition weight 408 that is equal to, less than, or greater than a requester engagement weight, depending on the duration of the time horizon 302. Thus, by applying the requester acquisition weight 408 to the requester acquisition function 208, and by applying the requester engagement weight 410 to the requester engagement function, the transportation matching system 102 generates the predicted requester function 212 as a balance between predicted requester acquisition and predicted requester engagement for the time horizon 302.

As mentioned above, the transportation matching system 102 further generates a balanced acquisition-engagement function based on a combination of a predicted provider function and a predicted requester function. Indeed, FIG. 5 illustrates an example flow for generating the balanced acquisition-engagement function 216.

As shown, the transportation matching system 102 utilizes the balancer model 214 to balance provider acquisition, provider engagement, requester acquisition, and requester engagement to generate the balanced acquisition-engagement function 216. Thus, for a given time horizon (e.g., the time horizon 302), the transportation matching system 102 generates a prediction for how spending for distributing lever content in accordance with various provider and requester acquisition and engagement levers will affect an overall transportation value (e.g., a number of matched transportation requests or a number of fulfilled transportation requests). As illustrated in FIG. 5, for example, the balanced acquisition-engagement function 216 shows a visual representation of a relationship between spend on distributing levers and corresponding transportation value.

In some embodiments, the transportation matching system 102 utilizes a balancer model 214 in the form of a neural network or an algorithm to determine linear or non-linear balances of spend between providers and requesters to improve (e.g., maximize) total transportation value for spend points over a time horizon. In these or other embodiments, the transportation matching system 102 utilizes various weights associated with predicted provider functions and predicted requester functions to determine balanced acquisition-engagement functions. For example, the transportation matching system further determines a predicted provider function weight and a predicted requester function weight. For example, the transportation matching system 102 determines the predicted provider function weight and the predicted requester function weight based on the respective time horizon 302. Indeed, the transportation matching system 102 can determine that a longer or shorter time horizon corresponds to a heavier or lighter predicted provider function weight. Additionally (or alternatively), the transportation matching system 102 can determine that a longer or shorter time horizon corresponds to a heavier or lighter predicted requester function weight.

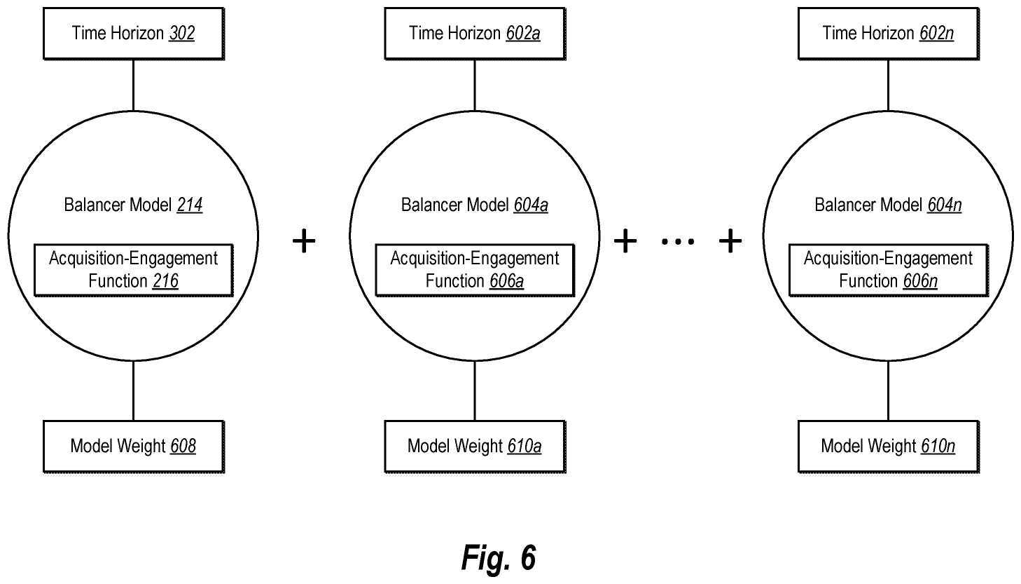

As mentioned, the transportation matching system 102 generates multiple balanced acquisition-engagement functions (e.g., the balanced acquisition-engagement function 216) using multiple balancer models (e.g., the balancer model 214). FIG. 6 illustrates an example weighting of multiple balanced acquisition-engagement functions, each corresponding to a different balancer model applied over a unique time horizon.

As illustrated in FIG. 6, the transportation matching system 102 utilizes the balancer model 214 to generate the balanced acquisition-engagement function 216 over the time horizon 302, as described in detail above. In addition, the transportation matching system 102 utilizes additional balancer models 604a-604n, each corresponding to a different time horizon 602a-602n, to generate respective balanced acquisition-engagement functions 606a-606n in accordance with the same described techniques. In some embodiments, the transportation matching system 102 utilizes or runs the illustrated balancer models in parallel. Thus, the transportation matching system 102 generates predictions of the overall impact on transportation value of various provider and requester acquisition and engagement levers over long-term time horizons and short-term time horizons. Indeed, the time horizons 602a-602n may be longer or shorter in duration than the time horizon 302 and may therefore result in different predicted acquisition-engagement functions 606a-606n.

As further illustrated, the transportation matching system 102 determines various model weights associated with the various balancer models to apply to the corresponding balanced acquisition-engagement functions. To determine the values of the model weights, the transportation matching system 102 determines a target time horizon. As mentioned above, in some embodiments the transportation matching system 102 receives input from an administrator device 116 to set a target time horizon. In other embodiments the transportation matching system 102 automatically sets a target time horizon based on other indications or inputs from the administrator device 116 such as a target growth rate, an indication to increase or decrease acquisition and/or engagement for providers and/or requesters, or an indication of one or more particular target providers and/or requesters.

Based on the target time horizon, the transportation matching system 102 determines the various model weights to apply to the balanced acquisition-engagement functions of the different balancer models. For example, the transportation matching system 102 determines a model weight 608 associated with the balancer model 214. To determine the model weight 608, the transportation matching system 102 determines an impact of the corresponding balanced acquisition-engagement function 216 with respect to the target time horizon. For instance, if the target time horizon is relatively short (e.g., 1 week) and the time horizon 302 associated with the balancer model 214 is relatively long (e.g., 6 months), the transportation matching system 102 may determine the model weight 608 as a relatively small weight when compared to model weights associated with balancer models that correspond to shorter time horizons. Contrarily, if the time horizon 302 is closer in duration to the target time horizon, the transportation matching system 102 determines a heavier value for the model weight 608.

Indeed, the transportation matching system 102 determines model weights 610a-610n associated with the balancer models 604a-604n, respectively. One or more of the model weights 610a-610n may have the same value or the model weights 610a-610n may have different values. In some embodiments, the transportation matching system 102 determines model weights based on comparisons (e.g., ratios) of corresponding time horizons 602a-602n with the target time horizons. For example, the transportation matching system 102 determines larger model weights for balancer models whose time horizons are closer in duration to the target time horizon. In these or other embodiments, the transportation matching system 102 determines the various model weights in accordance with a determination of a value decay over time.

Based on the various model weights, the transportation matching system 102 generates a weighted combination of the different acquisition-engagement functions of the balancer models which represents an overall prediction of how spend on utilization of various levers corresponds to an overall transportation value. In addition, the transportation matching system 102 determines or generates an electronic communication distribution strategy based on this overall transportation value function. To illustrate, the transportation matching system 102 determines which levers (e.g., provider acquisition levers, provider engagement levers, requester acquisition levers, and requester engagement levers) to utilize to provide which lever content to which individual providers and/or requesters and at what distribution times.

For example, based on the determination of the overall transportation value, the transportation matching system 102 identifies the different levers (e.g., the provider acquisition lever 304, the provider engagement lever 306, the requester acquisition lever 404, and the requester engagement lever 406) associated with the constituent balancer model 214 (and the other balancer models 604a-604n) that led to the overall transportation value function. In addition, the transportation matching system 102 determines the individual providers and/requesters associated with the various balancer models that led to the overall transportation value function.

Based on determining the levers corresponding to providers and requesters, the transportation matching system 102 further determines distribution times for utilizing the levers to the providers and requesters (e.g., within electronic communications). For example, based on historical information that indicates when individual providers/requesters respond to particular levers, the transportation matching system 102 determines a time value within a respective time horizon (e.g., the time horizon 302) to distribute an electronic communication that includes one or more levers. In some embodiments, the transportation matching system 102 further determines a geographic location associated with each of the balancer models (e.g., the balancer model 214).

Thus, the transportation matching system 102 generates an electronic communication distribution strategy that includes indicates of how and when to distribute lever content within electronic communications. For instance, based on an overall transportation value, the electronic communication distribution strategy is based on a weighted combination of multiple balanced acquisition-engagement functions that correspond to a balanced combination of one or more provider acquisition levers, one or more provider engagement levers, one or more requester acquisition levers, and one or more requester engagement levers for the first time horizon. Thus, on a specific user level (e.g., specific to individual providers and/or requesters), the electronic communication distribution strategy can include a plan for distributing electronic communications to one or more provider devices and one or more requester devices in particular locations and at particular distribution times.

In some embodiments, the electronic communication distribution strategy includes distribution parameters for each provider and requester, including a provider/requester identification, a distribution time, and a lever. Based on these distribution parameters, the transportation matching system 102 determines which lever to utilize for providing lever content to whom and at what time to achieve the most effective, balanced result as indicated by the overall transportation value function.

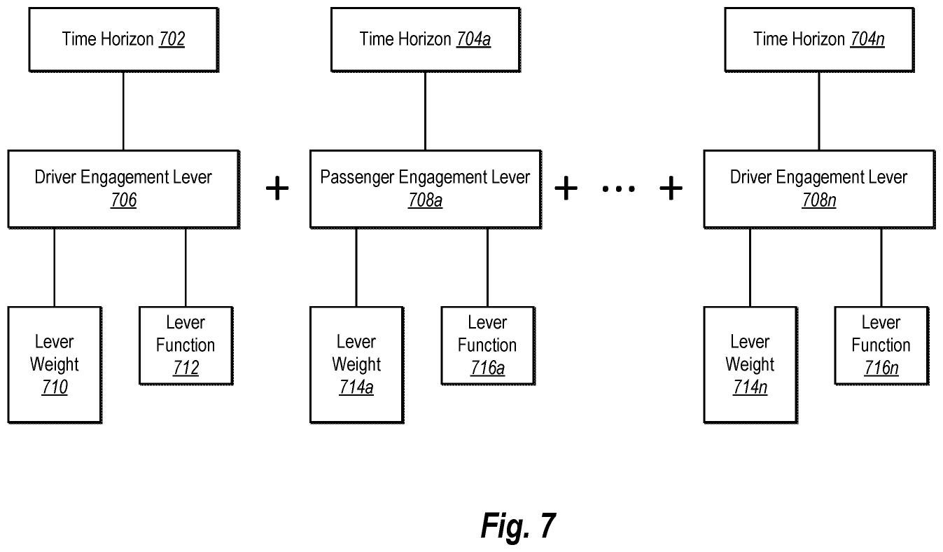

FIG. 7 illustrates an alternative embodiment whereby the transportation matching system 102 utilizes balancer models to generate an electronic communication distribution strategy. As shown in FIG. 7, the transportation matching system 102 utilizes a single balancer model to determine an overall transportation value function based on a number of levers. In addition, the transportation matching system 102 can determine the weighted combination of lever functions illustrated in FIG. 7 for each individual provider and requester. In some embodiments, rather than utilizing a single balancer model, each of the respective levers, along with its corresponding weight, lever function, and time horizon can be associated with an individual balancer model.

As illustrated, the transportation matching system 102 determines a lever function 712 associated with a driver engagement lever 706. Particularly, the transportation matching system 102 determines, for a given provider/requester, a correlation between spend for distributing lever content associated with the driver engagement lever 706 within the time horizon 702 and provider/requester value. Similarly, for the passenger engagement lever 708a, the transportation matching system 102 determines a lever function 716a that represents a correlation between distribution of lever content associated with the passenger engagement lever 708a within the time horizon 704a and provider/requester value. As shown, the transportation matching system 102 likewise determines lever functions 716a-716n for each of the different combinations of time horizons 704a-704n and levers (e.g., provider acquisition levers, provider engagement levers, requester acquisition levers, and requester engagement levers).

Further, the transportation matching system 102 determines lever weights associated with each of the various levers to apply to the corresponding lever functions. Indeed, the transportation matching system 102 determines the lever weights based on a target time horizon (e.g., as indicated by an administrator), as described above in relation to FIG. 6. In particular, the transportation matching system 102 determines lever weights based on a relationship between a respective time horizon and the target time horizon. For example, the transportation matching system 102 determines a lever weight 710 associated with the driver engagement lever 706. Similarly, the transportation matching system 102 determines lever weights 714a-714n associated with each of the other levers. As shown, the transportation matching system 102 determines a lever weight 710 heavier than other lever weights 714a-714n because, for example, the time horizon 702 is closer to the target time horizon than the other lever weights 714a-714n.

As illustrated in FIG. 7, the transportation matching system 102 generates a weighted combination of lever functions associated with the various illustrated levers to determine an overall transportation value function associated with an individual provider or requester. Based on the overall transportation value function, the transportation matching system 102 determines an electronic communication distribution strategy. Indeed, the transportation matching system 102 generates and provides electronic communications to the individual provider/requester to include the respective levers based on their impact on the overall transportation value function.

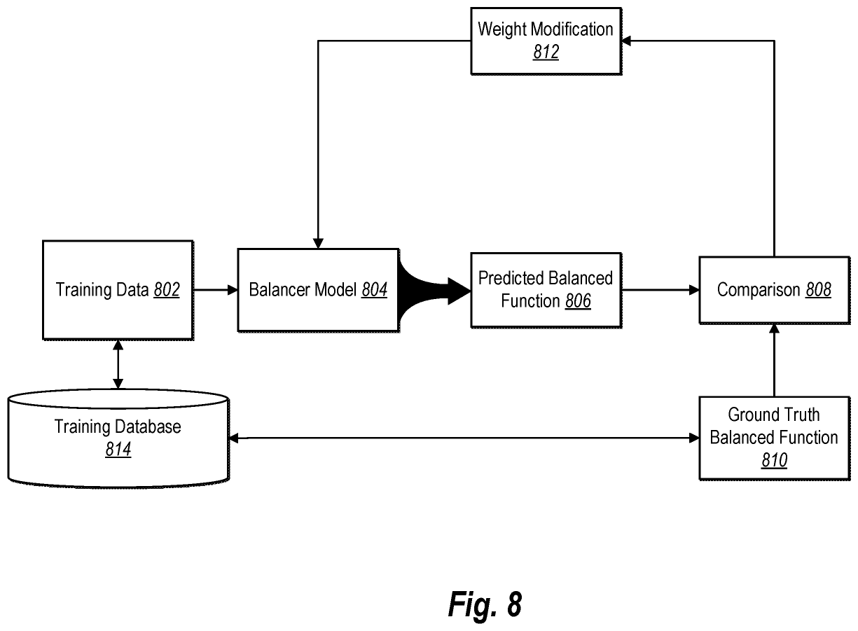

As mentioned, in some embodiments, the transportation matching system 102 trains the balancer models (e.g., the balancer model 214) to generate predicted functions (e.g., predicted provider functions, predicted requester functions, and/or balanced acquisition-engagement functions). FIG. 8 illustrates an example flow for training a balancer model 804 (e.g., the balancer model 214) in accordance with one or more embodiments.

As illustrated, the transportation matching system 102 accesses training data 802 from within a training database 814. In particular, the transportation matching system 102 accesses training records based on historical information such as previously distributed lever content associated with particular levers, corresponding distribution times, and provider/requester identifications of the individuals to whom the lever content distributed. The transportation matching system 102 further inputs the training data 802 into the balancer model 804, whereupon the balancer model 804 generates a predicted balanced function 806. In particular, the balancer model 804 generates a prediction of how spend correlates to a particular value (e.g., provider value, requester value, or transportation value) based on the training data 802.

In addition, the transportation matching system 102 performs a comparison 808 between the predicted balanced function 806 and ground truth balanced function 810. Particularly, the transportation matching system 102 accesses the ground truth balanced function 810 from the training database 814. The ground truth balanced function 810 is an actual function stored within the training database 814 and that corresponds to the training data 802. Thus, the transportation matching system 102 compares the predicted balanced function 806 with the ground truth balanced function 810 to determine an error or measure of loss associated with the balancer model 804.

To reduce the error or measure of loss, the transportation matching system 102 further performs a weight modification 812 to adjust or modify weights associated with the balancer model 804. For example, the transportation matching system 102 modifies one or more provider acquisition weights, provider engagement weights, requester acquisition weights, and/or requester engagement weights to reduce the error of the balancer model 804. In some embodiments, where the balancer model 804 is a neural network, the transportation matching system 102 performs the weight modification 812 by alternatively (or additionally) modifying internal weights associated with neurons within one or more layers of the neural network. By repeating the process illustrated in FIG. 8 to generate predictions, perform comparisons, and modify weights, the transportation matching system 102 improves the accuracy of the balancer model 804 until the error or measure of loss satisfies a threshold, thereby indicating that the balancer model 804 is accurate in its predictions.

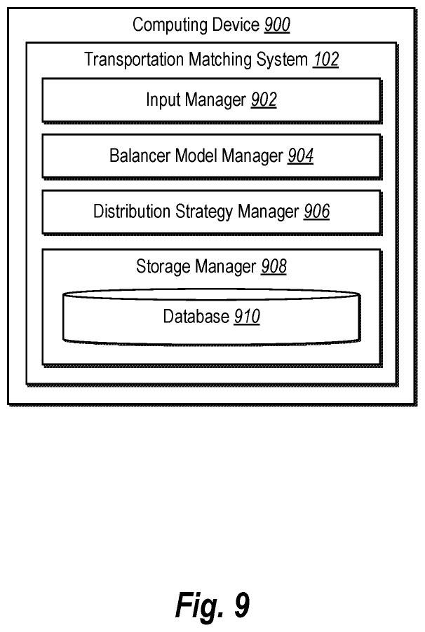

Looking now to FIG. 9, additional detail will be provided regarding components and capabilities of the transportation matching system 102. Specifically, FIG. 9 illustrates an example schematic diagram of the transportation matching system 102 on an example computing device 900 (e.g., one or more of the requester devices 112a-112n, the provider devices 108a-108n, the administrator device 116, and/or the server(s) 106). As shown in FIG. 9, the transportation matching system may include an input manager 902, a balancer model manager 904, a distribution strategy manager 906, and a storage manager 908.

As just mentioned, the transportation matching system 102 includes an input manager 902. In particular, the input manager identifies, detects, receives, or manages input from one or more devices such as the administrator device 116. For example, the input manager 902 receives input to set a target time horizon or some other parameter such as a target provider, a target requester, a target growth rate, and/or a target lever. Based on the input, the input manager 902 communicates with the balancer model manager 904 to generate one or more functions as described above by determining various weights in accordance with a target time horizon (or other parameter).

In addition, the transportation matching system 102 includes a balancer model manager 904. In particular, the balancer model manager 904 utilizes, implements, or manages one or more balancer models to determine or generate corresponding functions, as described above. For example, the balancer model manager 904 utilizes a balancer model to generate a predicted provider function, a predicted requester function, and a balanced acquisition-engagement function for a particular time horizon. In addition, in some embodiments, the balancer model manager 904 utilizes and weights a different balancer model for each of a plurality of time horizons, as described herein. In some embodiments, the balancer model manager 904 further communicates with the storage manager 908 to access training data from the database 910 (e.g., the training database 814) to train one or more balancer models.

Further the transportation matching system 102 includes a distribution strategy manager 906. In particular, the distribution strategy manager 906 manages, creates, generates, or determines an electronic communication distribution strategy for providing electronic communications (including lever content) to providers and/or requesters at particular times over a target time horizon. Indeed, the distribution strategy manager 906 communicates with the balancer model manager 904 to generate the electronic communication distribution strategy based on an overall transportation value function generated by the balancer model manager 904 for a target time horizon. The distribution strategy manager 906 can communicate with the storage manager 908 to access and store electronic communications, including lever content for various levers, for providing to providers and requesters.

In one or more embodiments, each of the components of the transportation matching system 102 are in communication with one another using any suitable communication technologies. Additionally, the components of the transportation matching system 102 can be in communication with one or more other devices including one or more client devices described above. It will be recognized that although the components of the transportation matching system 102 are shown to be separate in FIG. 9, any of the subcomponents may be combined into fewer components, such as into a single component, or divided into more components as may serve a particular implementation. Furthermore, although the components of FIG. 9 are described in connection with the transportation matching system 102, at least some of the components for performing operations in conjunction with the transportation matching system 102 described herein may be implemented on other devices within the environment.

The components of the transportation matching system 102 can include software, hardware, or both. For example, the components of the transportation matching system 102 can include one or more instructions stored on a computer-readable storage medium and executable by processors of one or more computing devices (e.g., the computing device 900). When executed by the one or more processors, the computer-executable instructions of the transportation matching system 102 can cause the computing device 900 to perform the methods described herein. Alternatively, the components of the transportation matching system 102 can comprise hardware, such as a special purpose processing device to perform a certain function or group of functions. Additionally or alternatively, the components of the transportation matching system 102 can include a combination of computer-executable instructions and hardware.

Furthermore, the components of the transportation matching system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the transportation matching system 102 may be implemented as part of a stand-alone application on a personal computing device or a mobile device. Alternatively or additionally, the components of the transportation matching system 102 may be implemented in any application that allows creation and delivery of marketing content to users, including, but not limited to, various applications.

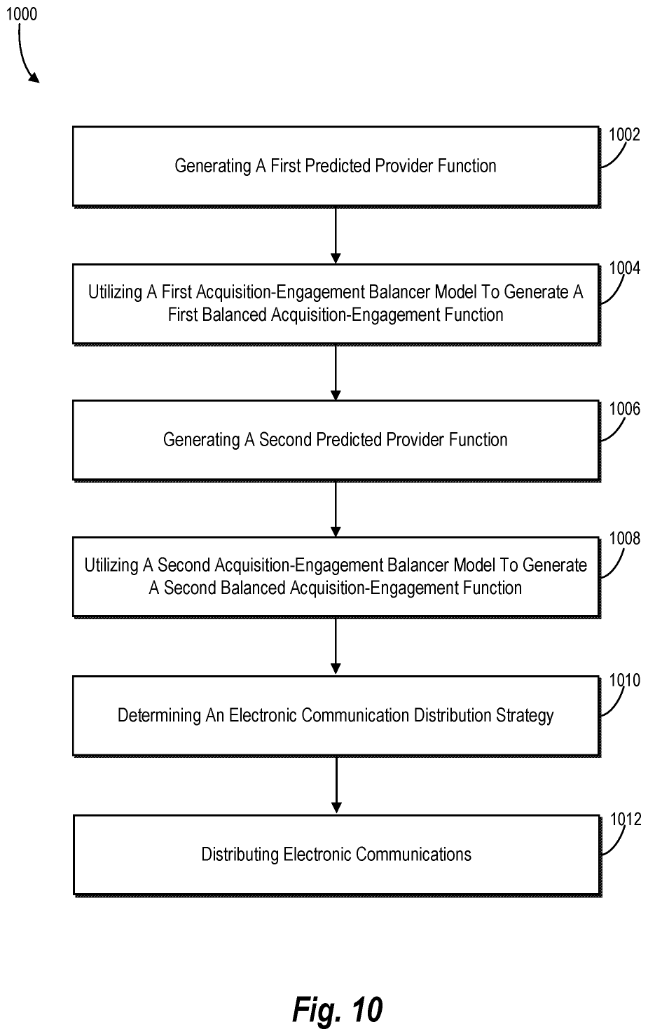

FIGS. 1-9, the corresponding text, and the examples provide a number of different systems, methods, and non-transitory computer readable media for providing electronic communications in accordance with an electronic communication distribution strategy. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 of balancing acquisition and engagement of transportation providers and requesters. As shown, the series of acts 1000 includes an act 1002 of generating a first predicted provider function. In particular, the act 1002 can involve generating, for a first time horizon, a first predicted provider function representing acquisition and engagement for transportation providers over the first time horizon and a first predicted requester function representing acquisition and engagement for transportation requesters over the first time horizon.

The series of acts 1000 also includes an act 1004 of utilizing a first acquisition-engagement balancer model to generate a first balanced acquisition-engagement function. In particular, the act 1004 can involve utilizing a first acquisition-engagement balancer model to generate a first balanced acquisition-engagement function for the first time horizon based on the first predicted provider function and the first predicted requester function.

In addition, the series of acts 1000 includes an act 1006 of generating a second predicted provider function. In particular, the act 1006 can involve generating, for a second time horizon, a second predicted provider function representing acquisition and engagement for transportation providers over the second time horizon and a second predicted requester function representing acquisition and engagement for transportation requesters over the second time horizon. The act 1006 can further involve generating the second predicted provider function and the second predicted requester function comprises utilizing a second acquisition-engagement balancer model in parallel with the first acquisition-engagement balancer model.

Further, the series of acts 1000 includes an act 1008 of utilizing a second acquisition-engagement balancer model to generate a second balanced acquisition-engagement function. In particular, the act 1008 can involve utilizing a second acquisition-engagement balancer model to generate a second balanced acquisition-engagement function for the second time horizon based on the second predicted provider function and the second predicted requester function.

As illustrated, the series of acts 1000 further includes an act 1010 of determining an electronic communication distribution strategy. In particular, the act 1010 can involve determining, based on a weighted combination of the first balanced acquisition-engagement function and the second balanced acquisition-engagement function, an electronic communication distribution strategy. The act 1010 can further involve utilizing the weighted combination of the first balanced acquisition-engagement function and the second balanced acquisition-engagement function to identify a balanced combination of one or more provider acquisition levers, one or more provider engagement levers, one or more requester acquisition levers, and one or more requester engagement levers for distributing electronic communications to transportation providers and requesters. Accordingly, for example, the electronic communication distribution strategy can identify a strategic combination of communication channels, communication content, and communication targets for distributing electronic communications with the purpose of engaging and/or acquiring transportation providers and requesters in a balanced manner (e.g., to maximize value or revenue for a given target time period).

The series of acts 1000 further includes an act 1012 of distributing electronic communications. In particular, the act 1012 can involve distributing electronic communications in accordance with the electronic communication distribution strategy. In some embodiments, the electronic communications can include content associated with engaging or acquiring providers and requesters as dictated by the electronic communication distribution strategy. The act 1012 can involve distributing electronic communications directly (e.g., by the transportation matching system 102) or distributing the electronic communications by way of a third party. For example, the act 1012 can involve causing a third-party electronic communication distribution system (e.g., a social networking system, a search engine system, or a targeted ad-delivery system) to distribute electronic communications.

The electronic communication distribution strategy can include a plan for distributing electronic communications to one or more provider devices and one or more requester devices in accordance with the balanced combination of one or more provider acquisition levers, one or more provider engagement levers, one or more requester acquisition levers, and one or more requester engagement levers. In addition, the act 1010 can involve, determining respective distribution times to distribute the electronic communications to the one or more provider devices and the one or more requester devices in accordance with the balanced combination of one or more provider acquisition levers, one or more provider engagement levers, one or more requester acquisition levers, and one or more requester engagement levers. The act 1010 can additionally (or alternatively) involve determining respective distribution times to distribute the provider lever content and the requester lever content.

Indeed, the series of acts 1000 can include an act of receiving an indication from an administrator device to set a target time horizon for distributing electronic communications. Thus, the act 1010 can involve, based on the target time horizon, weighting the first balanced acquisition-engagement function with a first weight and weighting the second balanced acquisition-engagement function with a second weight. The series of acts 1000 can further involve an act of utilizing one or more additional acquisition-engagement balancer models to generate one or more additional balanced acquisition-engagement functions, each corresponding to a respective time horizon. In addition, the series of acts 1000 can include an act of modifying the electronic communication distribution strategy based on weighting the one or more additional balanced acquisition-engagement functions. Further, the series of acts 1000 can include an act of training the first acquisition-engagement balancer model to generate predicted the first balanced acquisition-engagement function by modifying one or more weights associated with the first-acquisition engagement balancer model to reduce a measure of loss.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that the transportation matching system 102 can comprise implementations of the computing device 1100, including, but not limited to, the provider devices 108a-108n, the requester devices 112a-112n, the administrator device 116, and/or the server(s) 106. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requester or provider) to provide input to (such as user strokes), receive output from, and otherwise transfer data to and from the computing device 1100. These I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

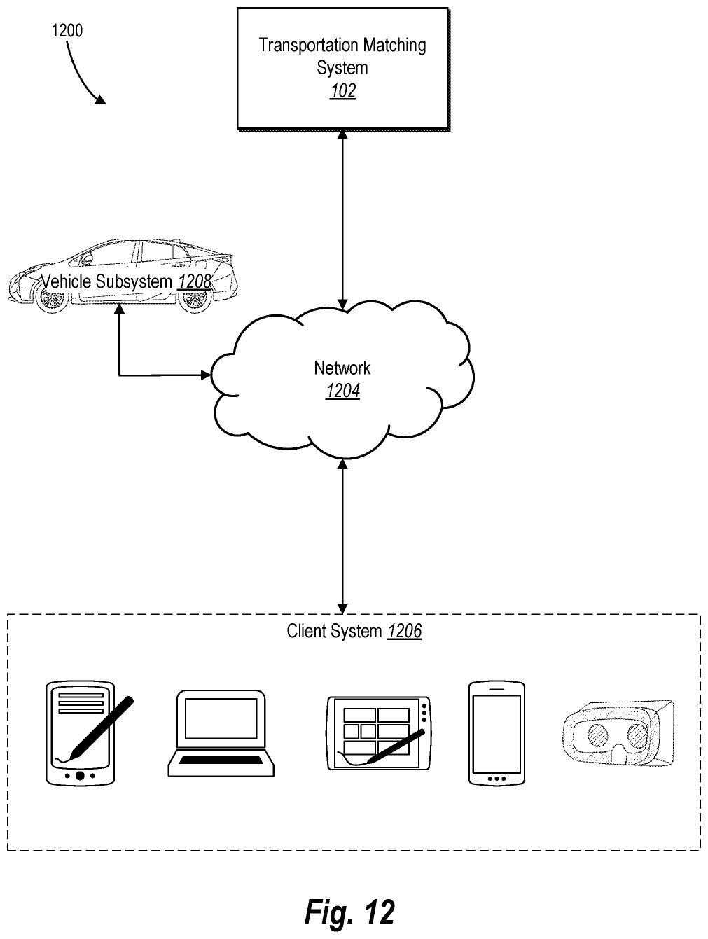

FIG. 12 illustrates an example network environment 1200 of the transportation matching system 102. The network environment 1200 includes a client device 1206 (e.g., one or more of the provider devices 108a-108n, the requester devices 112a-112n, and/or the administrator device 116), a transportation matching system 102, and a vehicle subsystem 1208 connected to each other by a network 1204. Although FIG. 12 illustrates a particular arrangement of the client device 1206, transportation matching system 102, vehicle subsystem 1208, and network 1204, this disclosure contemplates any suitable arrangement of client device 1206, transportation matching system 102, vehicle subsystem 1208, and network 1204. As an example, and not by way of limitation, two or more of client device 1206, transportation matching system 102, and vehicle subsystem 1208 communicate directly, bypassing network 1204. As another example, two or more of client device 1206, transportation matching system 102, and vehicle subsystem 1208 may be physically or logically co-located with each other in whole or in part. Moreover, although FIG. 12 illustrates a particular number of client devices 1206, transportation matching systems 102, vehicle subsystems 1208, and networks 1204, this disclosure contemplates any suitable number of client devices 1206, transportation matching systems 102, vehicle subsystems 1208, and networks 1204. As an example, and not by way of limitation, network environment 1200 may include multiple client device 1206, transportation matching systems 102, vehicle subsystems 1208, and networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, transportation matching system 102, and vehicle subsystem 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at client device 1206 to access network 1204. A client device 1206 may enable its user to communicate with other users at other client devices 1206.

In particular embodiments, client device 1206 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 1206 one or more Hyper Text Markup Language (“HTML”) files responsive to the HTTP request. Client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. Transportation matching system 102 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 102. In addition, the dynamic transportation matching system may manage identities of service requesters such as users/requesters. In particular, the dynamic transportation matching system may maintain requester data such as driving/riding histories, personal data, or other user data in addition to navigation and/or traffic management services or other location services (e.g., GPS services).

In particular embodiments, the transportation matching system 102 may manage transportation matching services to connect a user/requester with a vehicle and/or provider. By managing the transportation matching services, the transportation matching system 102 can manage the distribution and allocation of resources from vehicle systems and user resources such as GPS location and availability indicators, as described herein.

Transportation matching system 102 may be accessed by the other components of network environment 1200 either directly or via network 1204. In particular embodiments, transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 102 to manage, retrieve, modify, add, or delete, the information stored in data store.

In particular embodiments, transportation matching system 102 may provide users with the ability to take actions on various types of items or objects, supported by transportation matching system 102. As an example, and not by way of limitation, the items and objects may include transportation matching networks to which users of transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 102 or by an external system of a third-party system, which is separate from transportation matching system 102 and coupled to transportation matching system 102 via a network 1204.

In particular embodiments, transportation matching system 102 may be capable of linking a variety of entities. As an example, and not by way of limitation, transportation matching system 102 may enable users to interact with each other or other entities, or to allow users to interact with these entities through an application programming interfaces (“API”) or other communication channels.

In particular embodiments, transportation matching system 102 may include a variety of servers, sub-systems, programs, modules, logs, and data stores. In particular embodiments, transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. Transportation matching system 102 may also include suitable components such as network interfaces, security mechanisms, load balancers, failover servers, management-and-network-operations consoles, other suitable components, or any suitable combination thereof. In particular embodiments, transportation matching system 102 may include one or more user-profile stores for storing user profiles. A user profile may include, for example, biographic information, demographic information, behavioral information, social information, or other types of descriptive information, such as interests, affinities, or location.

The web server may include a mail server or other messaging functionality for receiving and routing messages between transportation matching system 102 and one or more client devices 1206. An action logger may be used to receive communications from a web server about a user's actions on or off transportation matching system 102. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of transportation matching system 102. A privacy setting of a user determines how particular information associated with a user can be shared. The authorization server may allow users to opt in to or opt out of having their actions logged by transportation matching system 102 or shared with other systems, such as, for example, by setting appropriate privacy settings. Third-party-content-object stores may be used to store content objects received from third parties. Location stores may be used for storing location information received from client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—i.e., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once—i.e., split up throughout the vehicle subsystem 1208 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the transportation matching system 102. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for managing transportation services comprising:
generating, for a first time horizon, a first predicted provider function representing acquisition and engagement for transportation providers over the first time horizon and a first predicted requester function representing acquisition and engagement for transportation requesters over the first time horizon;
utilizing a first acquisition-engagement balancer model to generate a first balanced acquisition-engagement function for the first time horizon based on the first predicted provider function and the first predicted requester function;
generating, for a second time horizon, a second predicted provider function representing acquisition and engagement for transportation providers over the second time horizon and a second predicted requester function representing acquisition and engagement for transportation requesters over the second time horizon;
utilizing a second acquisition-engagement balancer model to generate a second balanced acquisition-engagement function for the second time horizon based on the second predicted provider function and the second predicted requester function;
determining, based on a weighted combination of the first balanced acquisition-engagement function and the second balanced acquisition-engagement function, an electronic communication distribution strategy; and
distributing electronic communications in accordance with the electronic communication distribution strategy.

2. The method of claim 1, wherein determining the electronic communication distribution strategy comprises utilizing the weighted combination of the first balanced acquisition-engagement function and the second balanced acquisition-engagement function to identify a balanced combination of one or more provider acquisition levers, one or more provider engagement levers, one or more requester acquisition levers, and one or more requester engagement levers for the first time horizon.

3. The method of claim 2, wherein distributing the electronic communications in accordance with the electronic communication distribution strategy comprises distributing electronic communications to one or more provider devices and one or more requester devices in accordance with the balanced combination of one or more provider acquisition levers, one or more provider engagement levers, one or more requester acquisition levers, and one or more requester engagement levers.

4. The method of claim 3, wherein determining the electronic communication distribution strategy further comprises determining respective distribution times to provide the electronic communications to the one or more provider devices and the one or more requester devices in accordance with the balanced combination of one or more provider acquisition levers, one or more provider engagement levers, one or more requester acquisition levers, and one or more requester engagement levers.

5. The method of claim 1, further comprising:
receiving an indication from an administrator device to set a target time horizon for distributing electronic communications; and.
weighting the first balanced acquisition-engagement function with a first weight and weighting the second balanced acquisition-engagement function with a second weight based on the target time horizon.

6. The method of claim 1, further comprising:
utilizing one or more additional acquisition-engagement balancer models to generate one or more additional balanced acquisition-engagement functions, each corresponding to a respective time horizon; and
modifying the electronic communication distribution strategy based on the one or more additional balanced acquisition-engagement functions.

7. The method of claim 1, further comprising training the first acquisition-engagement balancer model to generate the first balanced acquisition-engagement function by modifying one or more weights associated with the first-acquisition engagement balancer model to reduce a measure of loss.

8. A non-transitory computer readable medium for managing transportation services comprising instructions that, when executed by at least one processor, cause a computer device to:
generate, for a first time horizon, a first predicted provider function representing acquisition and engagement for transportation providers over the first time horizon and a first predicted requester function representing acquisition and engagement for transportation requesters over the first time horizon;
utilize a first acquisition-engagement balancer model to generate a first balanced acquisition-engagement function for the first time horizon based on the first predicted provider function and the first predicted requester function;
generate, for a second time horizon, a second predicted provider function representing acquisition and engagement for transportation providers over the second time horizon and a second predicted requester function representing acquisition and engagement for transportation requesters over the second time horizon;
utilize a second acquisition-engagement balancer model to generate a second balanced acquisition-engagement function for the second time horizon based on the second predicted provider function and the second predicted requester function;
determine, based on a weighted combination of the first balanced acquisition-engagement function and the second balanced acquisition-engagement function, an electronic communication distribution strategy; and
distribute electronic communications in accordance with the electronic communication distribution strategy.

9. The non-transitory computer readable medium of claim 8, wherein the instructions cause the computer device to determine the electronic communication distribution strategy by utilizing the weighted combination of the first balanced acquisition-engagement function and the second balanced acquisition-engagement function to identify a balanced combination of one or more provider acquisition levers, one or more provider engagement levers, one or more requester acquisition levers, and one or more requester engagement levers for the first time horizon.

10. The non-transitory computer readable medium of claim 9, wherein distributing the electronic communications in accordance with the electronic communication distribution strategy comprises distributing electronic communications to one or more provider devices and one or more requester devices in accordance with the balanced combination of one or more provider acquisition levers, one or more provider engagement levers, one or more requester acquisition levers, and one or more requester engagement levers.

11. The non-transitory computer readable medium of claim 10, wherein the instructions cause the computer device to determine respective distribution times to provide the electronic communications to the one or more provider devices and the one or more requester devices in accordance with the balanced combination of one or more provider acquisition levers, one or more provider engagement levers, one or more requester acquisition levers, and one or more requester engagement levers.

12. The non-transitory computer readable medium of claim 8, further comprising instructions that, when executed by the at least one processor, cause the computer device to:
receive an indication from an administrator device to set a target time horizon for distributing electronic communications; and
weight the first balanced acquisition-engagement function with a first weight and weight the second balanced acquisition-engagement function with a second weight based on the target time horizon.

13. The non-transitory computer readable medium of claim 8, further comprising instructions that, when executed by the at least one processor, cause the computer device to:
utilize one or more additional acquisition-engagement balancer models to generate one or more additional balanced acquisition-engagement functions, each corresponding to a respective time horizon; and
modify the electronic communication distribution strategy based on the one or more additional balanced acquisition-engagement functions.

14. The non-transitory computer readable medium of claim 8, further comprising instructions that, when executed by the at least one processor, cause the computer device to train the first acquisition-engagement balancer model to generate the first balanced acquisition-engagement function by modifying one or more weights associated with the first-acquisition engagement balancer model to reduce a measure of loss.

15. A system for managing transportation services comprising:
at least one processor; and
a non-transitory computer readable medium comprising instructions that, when executed by the at least one processor, cause the system to:
generate, for a first time horizon, a first predicted provider function representing acquisition and engagement for transportation providers over the first time horizon and a first predicted requester function representing acquisition and engagement for transportation requesters over the first time horizon;
utilize a first acquisition-engagement balancer model to generate a first balanced acquisition-engagement function for the first time horizon based on the first predicted provider function and the first predicted requester function;
generate, for a second time horizon, a second predicted provider function representing acquisition and engagement for transportation providers over the second time horizon and a second predicted requester function representing acquisition and engagement for transportation requesters over the second time horizon;
utilize a second acquisition-engagement balancer model to generate a second balanced acquisition-engagement function for the second time horizon based on the second predicted provider function and the second predicted requester function;
determine, based on a weighted combination of the first balanced acquisition-engagement function and the second balanced acquisition-engagement function, an electronic communication distribution strategy; and
distribute electronic communications in accordance with the electronic communication distribution strategy.

16. The system of claim 15, wherein the instructions cause the system to determine the electronic communication distribution strategy by utilizing the weighted combination of the first balanced acquisition-engagement function and the second balanced acquisition-engagement function to identify a balanced combination of one or more provider acquisition levers, one or more provider engagement levers, one or more requester acquisition levers, and one or more requester engagement levers for the first time horizon.

17. The system of claim 16, wherein distributing the electronic communications in accordance with the electronic communication distribution strategy comprises distributing electronic communications to one or more provider devices and one or more requester devices in accordance with the balanced combination of one or more provider acquisition levers, one or more provider engagement levers, one or more requester acquisition levers, and one or more requester engagement levers.

18. The system of claim 17, wherein the instructions cause the system to determine respective distribution times to provide the electronic communications to the one or more provider devices and the one or more requester devices in accordance with the balanced combination of one or more provider acquisition levers, one or more provider engagement levers, one or more requester acquisition levers, and one or more requester engagement levers.

19. The system of claim 15, further comprising instructions that, when executed by the at least one processor, cause the system to:
receive an indication from an administrator device to set a target time horizon for distributing electronic communications; and
weight the first balanced acquisition-engagement function with a first weight and weight the second balanced acquisition-engagement function with a second weight based on the target time horizon.

20. The system of claim 15, further comprising instructions that, when executed by the at least one processor, cause the system to:
utilize one or more additional acquisition-engagement balancer models to generate one or more additional balanced acquisition-engagement functions, each corresponding to a respective time horizon; and
modify the electronic communication distribution strategy based on the one or more additional balanced acquisition-engagement functions.
